(19) United States
(12) Patent Application Publication
(10) Pub. No.: US 2025/0338256 A1
(43) Pub. Date: Oct. 30, 2025

(54) SIGNAL SCANNING AND SYMBOL PRESENTATION FOR NON-TERRESTRIAL NETWORKS

(71) Applicant: T-Mobile USA, Inc., Bellevue, WA (US)

(72) Inventors: Chad Au, Kirkland, WA (US); Gaviphat Lekutai, Kirkland, WA (US); Jun Liu, Bellevue, WA (US); Kun Lu, Bellevue, WA (US)

(21) Appl. No.: 18/651,047

(22) Filed: Apr. 30, 2024

(51) Int. Cl. H04W 72/02; H04W 72/0446; H04W 84/06

(52) U.S. Cl. CPC H04W 72/02; H04W 72/0446; H04W 84/06

(57) ABSTRACT

Techniques for presenting a symbol on a display of a wireless device indicative of wireless resources based on network states and device states are discussed herein. In some example, the techniques include determining when to scan for wireless resources and/or which of multiple network identifiers to display on a status bar of the device, when the device is operating in a cellular network of a wireless communications provider that has areas of coverage provided by a non-terrestrial network. In some examples, a symbol indicative of a wireless resource can be determined based at least in part on a policy, which may be based on device characteristics and/or an availability or non-availability of one or more radio frequency resources. Network identifiers might include, for example, symbols that indicate 3G, 4G, LTE, 5G, 5G non-terrestrial networks (NTN) and so forth, corresponding to different wireless network standards.

### BACKGROUND

Cellular communication devices use network radio access technologies to communicate wirelessly with geographically distributed cellular base stations. Long-Term Evolution (LTE) is an example of a widely implemented radio access technology that is used in 4th Generation (4G) communication systems. New Radio (NR) is a newer radio access technology that is used in 5th Generation (Fifth Generation, or 5G) communication systems. Standards for LTE and NR radio access technologies have been developed by the 3rd Generation Partnership Project (3GPP) for use by wireless communication carriers.

Existing 4G networks use relatively low radio frequencies, such as frequencies in bands below 6 GHz. 5G networks are able to use an extended range of frequency bands compared to 4G networks, such as higher frequency bands in the 6-100 GHz spectrum. Frequency bands in the 6-100 GHz spectrum are generally referred as mm Wave frequency bands as their wavelength is within the millimeter range. Radio communications using the higher frequency 5G bands can support higher data speeds, but also have disadvantages compared to the lower frequency bands. Specifically, radio signals in the higher frequencies have shorter range and are more easily blocked by physical objects. Accordingly, the ability for a communication device to communicate using higher-frequency 5G bands may be sporadic as the device is physically moved.

Communication devices such as smartphones often have a status bar that shows, among other things, the current signal strength and/or signal quality of the current wireless connection with a base station. In addition, the status bar may have a network indicator, such as an icon or symbol, that indicates the network type being used for the current wireless connection. For example, the network indicator might comprise a “4G LTE” symbol when the current connection is over an LTE network, and a “5G” symbol when the current connection is over a 5G network.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment implementing signal scanning and symbol presentation for non-terrestrial networks.

FIG. 2 is a block diagram of a communication network that implements terrestrial and/or non-terrestrial 4G technologies and 5G technologies and a user equipment implementing the techniques discussed herein.

FIG. 3 is an example process for signal scanning and symbol presentation for various terrestrial and non-terrestrial networks, as discussed herein.

FIG. 4 illustrates an example computing device to implement the symbol determination and/or presentation techniques, as discussed herein.

FIG. 5 illustrates an example process for signal scanning and/or symbol presentation for non-terrestrial networks.

### DETAILED DESCRIPTION

Described herein are techniques for determining when to scan for wireless resources and/or which of multiple network identifiers to display on the status bar of a wireless communication device (e.g., user equipment (UE)), when the device is operating in a cellular network of a wireless communications provider that has areas of coverage provided by a non-terrestrial network. In some examples, a symbol indicative of a wireless resource can be determined based at least in part on a policy, which may be based on UE characteristics and/or an availability or non-availability of one or more radio frequency resources. Network identifiers might include, for example, symbols that indicate 3G, 4G, LTE, 5G, 5G non-terrestrial networks (NTN) and so forth, corresponding to different wireless network standards.

In some examples, a wireless provider may use a variety of terrestrial networks (TN) and non-terrestrial networks (NTN) to provide wireless communications to a UE. For example a network may comprise terrestrial 4G base stations and terrestrial 5G base stations. However, despite widespread installation of such terrestrial (e.g., ground-based) base stations, there may still be areas in an environment where signal strength is low or not available. In some examples, a wireless provide may allocate wireless resources to a non-terrestrial base station (e.g., a non-terrestrial network) that can provide wireless coverage.

The described techniques may be useful when a wireless communication device is within an area that is supported by either terrestrial networks (TN) and/or non-terrestrial networks (NTN), for example. In some cases, TN signals may extend primarily over populated areas, whereas NTN may cover those as well as unpopulated areas.

When using 4G and/or 5G architectures, an initial connection between the UE and a base station can be configured based on base station system information. System information can be broadcast by the base station in data objects referred to as System Information Blocks (SIBs) or Master Information Blocks (MIBs). System information may include information relating to cell access, scheduling, communication channels and frequencies, network identifiers, tracking area codes (TACs), cell IDs, status, power levels, paging information, neighboring cells, etc.

In some examples, the UE may be configured to receive 5G NR configuration information during initial attachment to the TN base station. Specifically, the TN base station may use SIBs, MIBs, and/or Radio Resource Control (RRC) signaling with the UE to specify the frequencies that are potentially used for NR broadcast transmissions by the NR base station. Based on this information, the UE can limit the searching of NR frequencies to those frequencies that are actually being used (e.g., by the NR base station) and avoid searching other frequencies that are not used by the communication provider in the area where the UE is located.

In some examples, the UE may be preconfigured with stored information indicating the possible frequencies of NR transmissions by either the communication provider or by NR base stations in an NTN. In some examples, the UE can be preconfigured with stored information indicating NTN RF resources that can be associated with TN RF resources, such that if the UE has detected TN RF resources withing a predetermined time (or other metric) then the UE can scan for NTN RF resources when other conditions are met (as discussed herein).

In some examples, the UE may be configured to receive 5G NR configuration information from an NR (and/or an LTE) terrestrial base station. In some examples, the configuration information may include a description of first radio frequency (RF) resources to be used by the NR terrestrial base station and second RF resources to be used by a non-terrestrial network if the terrestrial network is not available. In some examples, configuration information may include priority information or policy information indicating a priority or order in which a UE may scan for various RF resources and/or policy information indicating when a network symbol is to be displayed or otherwise presented by the UE.

In some examples, the signal scanning operations described herein may be limited to certain times or situations to reduce power consumption that may be involved in the signal scanning. By way of example and without limitation, scanning for one or more terrestrial network and/or non-terrestrial network can be based on an availability or non-availability of other networks, based on UE conditions, based on policy information, and the like. For example, the UE may be configured to determine the probability that a user of the device is looking at the display of the device, and to pause or otherwise refrain from signal scanning when the user is unlikely to be looking at the display. Whether the user is likely to be looking at the display may be determined based on factors such as whether the display is on, whether a lock screen or screen saver is active, whether the device is locked, whether the device's camera is obscured, whether a human face can be detected with the camera, whether the device is facing downward, whether the device is moving, and so forth. Additional UE conditions that may be used to determine whether to pause or refrain from scanning include, but are not limited to, whether the device is plugged into power or is charging, a battery level of the device, a type of application running on the device or a call to be made, a time of day, congestion information and/or latency information associated with one or more networks, and the like. Additional UE state data, UE conditions, and other information to be used to determine to initiate scanning operations or to present a symbol are discussed throughout the disclosure.

In some examples, power consumption may be reduced by scanning periodically, rather than continuously, at intervals that increase in length over time. For example, the interval length may start at 1 second, increase to 2 seconds, increase to 4 seconds, and so on until reaching a maximum interval length. If or when an NR signal is found, the UE can display the 5G TN symbol, the UE can reset the interval length (e.g., of a timer) to its lowest or beginning value, and the UE can begin the process again, first at an interval length of 1 second, increasing to 2 seconds, and so forth until a suitable RF signal is no longer present or until reaching the maximum interval length. The use of varying intervals such as this allows quick updates in conditions where 5G coverage is changing frequently, while conserving power in conditions where coverage is relatively unchanging. Likewise, depending on location, some implementations may have the device perform signal scanning of NTN as limited to certain times to reduce power consumption, and display the 5G NTN symbol if such an NR signal is found (and/or if other conditions are satisfied or met).

In some examples, other techniques may be used when determining which of multiple network identifiers to display. While in connected mode, for example, the UE may be configured to detect NR communication link failure(s) and may, in response, prevent the 5G TN or NTN symbol from being displayed for a set time period. As another example, when the UE goes from connected mode to idle mode, the UE may prevent the displayed network identifier from being changed for a set time period. Specifically, if the NR link was present when the UE went into idle mode, the 5G network symbol can be displayed during the time period. If the NR link was not present when the UE went into idle mode, the legacy network symbol (e.g., the network symbol most recently displayed) can be displayed during the time period. This technique may improve the accuracy of network identifier display by controlling the UE to not display the 5G symbol after 5G failures, regardless of whether 5G TN or NTN coverage is indicated by other information or measurements. In addition or in the alternative, signal scanning may be paused during the mentioned time periods, which can reduce the amount of power that would otherwise be consumed by signal scanning.

Although certain techniques are described in the context of TN networks, the techniques described herein may also be used with different network types, standards, and technologies. That is, the techniques may be used more generally for TN and NTN wireless communication networks.

Furthermore, although the techniques are described in the context of a single NR base station, the techniques may also be used in conjunction with cell groups (or groups of base stations of the same radio access technology (e.g., 4G or 5G) or groups of different radio access technology), where a communication device might use carrier aggregation to concurrently communicate with more than one NR base station (or dual connectivity to concurrently communicate with LTE/NR base stations).

In some instances, the described techniques allow a cellular communication device (such as a UE) to efficiently determine which of multiple network identifiers should be displayed to device users, while also reducing the amount of signal scanning and the amount of power consumed by signal scanning. While conserving power, the described techniques also provide reliable indications of network coverage, at frequencies that are high enough to satisfy user needs and to provide a good customer experience.

The systems, devices, and techniques described herein can improve the functioning of a device (e.g., a user equipment) by intelligently scanning for resources and/or presenting symbol(s) indicative of a wireless resource based on one or more policies and/or UE conditions. For example, the techniques can include determining a connection state and/or characteristics of a network for determining symbol(s). Presenting symbol(s) in accordance with the techniques discussed herein can improve a user experience by informing users of available network resources and associated expectation of the network resources. Further, the techniques discussed herein may conserve battery and/or processing time of a UE by determining to display a symbol based on a policy (e.g., without searching for an associated signal). The techniques may improve a functioning of a network by reducing initiation of communications where network resources are not available (and/or when a connection has failed), which may reduce signaling and associated congestion. These and other improvements to the functioning of a computer and network are discussed herein.

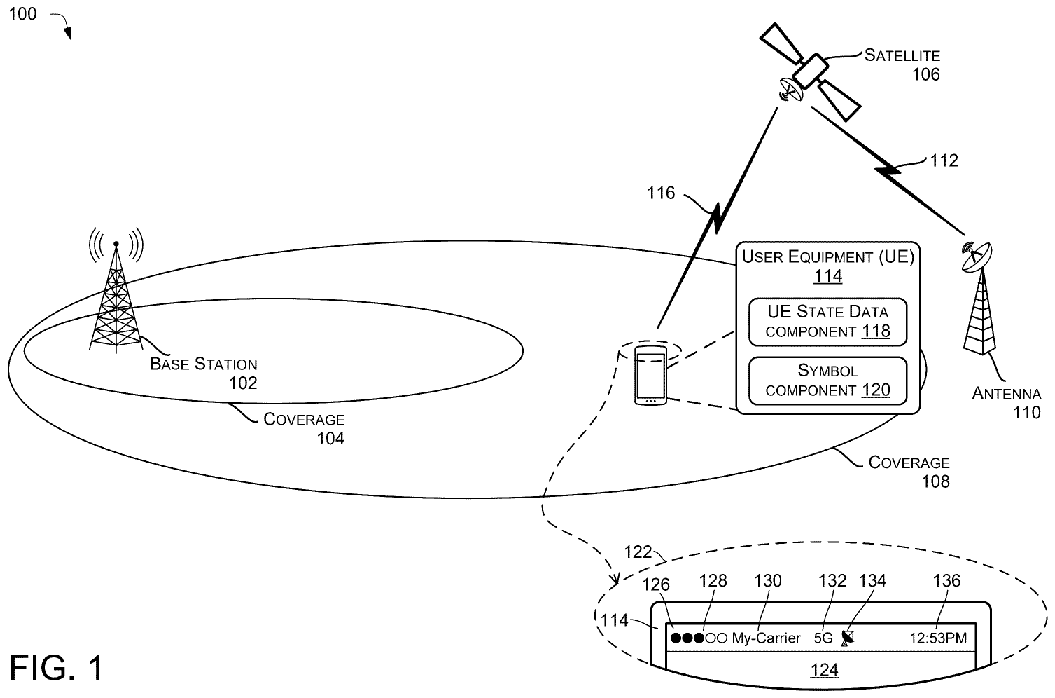

FIG. 1 illustrates an example environment 100 implementing signal scanning and symbol presentation for non-terrestrial networks.

As illustrated, the environment 100 includes a base station 102 with an associated coverage 104 and a satellite 106 with an associated coverage 108. In some examples, the satellite 106 can be in communication with an antenna 110 via a connection 112. In some examples, the base station 102 and/or the antenna 110 can further be connected to one or more core networks (e.g., one or more 4G core networks or 5G networks) to facilitate communication by and between computing devices, as discussed herein.

In some examples, the environment 100 can further include a user equipment (UE) 114 (also referred to as a device 114) communicatively coupled with the satellite 106 via a connection 116. Accordingly, the UE 114 can send and/or receive data to and from the satellite 106 via the connections 116 and 112.

The UE 114 can include, but is not limited to, one or more of a UE state data component 118 and/or a symbol component 120.

In some examples, and as discussed throughout this disclosure, the base station 102 and/or the satellite 106 can support any radio access technology, such as 4G and/or 5G technology. That is, the base station 102 and/or the satellite 106 may comprise an eNodeB and/or a gNodeB to facilitate communications by and between various user equipment. Additional examples and implementations are discussed throughout this disclosure.

By way of example and without limitation, the UE state data component 118 can include functionality to determine state data associated with the UE 114 to aid in determining when to initiate, continue, pause, and/or refrain from scanning for one or more radio frequency resources. By way of example and without limitation, in some examples the UE state data component 118 can determine (but is not limited to) the following data or conditions: whether a display of the UE is on, whether a lock screen or screen saver is active, whether the device is locked, whether the device's camera is obscured, whether a human face can be detected with the camera, whether the device is facing downward, whether the device is moving, and so forth. Additional UE state data may include, but are not limited to, whether the device is plugged into power or is charging, a battery level of the device, a type of application running on the device or a call to be made, a time of day, congestion information and/or latency information associated with one or more networks, and the like. Additional UE state data and/or network conditions are discussed throughout this disclosure.

By way of example and without limitation, the symbol component 120 can include functionality to determine which symbol to present on a display of the UE 114, for example, for indicating what types of connections are available and/or what type of connection is associated with the UE 114 (e.g., to what types of base station(s) the UE 114 is connected). By way of example, and without limitation, the UE can present a symbol indicating “4G” or “5G” when the UE is connected to a standalone base station associated with the particular radio access technology. In some examples, when the UE is using dual-connectivity or carrier aggregation, the UE can present a network indicator indicative of the lower-quality network or of the higher-quality network based on policy information and/or connection metrics (e.g., bandwidth, latency, jitter, etc.). In some examples, when any terrestrial networks are not available, the symbol component 120 can scan for non-terrestrial networks and if an attachment is made, the symbol component 120 can present a symbol of the network identifier (e.g., “4G,” “5G”, and the like) as well as a symbol (e.g., an icon of a satellite or “NTN” text, and the like) indicating that the connection is non-terrestrial. Additional examples and discussion are provided throughout this disclosure.

A detail view 122 illustrates an example of presenting symbol(s) on the UE 114 according to the techniques discussed herein. As illustrated, the UE 114 is in the coverage area 108 associated with the satellite 106 but outside of the coverage area 104 associated with the base station 102. In some examples, the base station 102 can use first RF resources to communicate with UEs within the coverage area 104 and the satellite 106 can use second RF resources to communicate with UEs within the coverage area 108. As can be understood, because the UE 114 is outside of the coverage area 104 the first RF frequency resources are not available to the UE 114, while the second RF resources are available to the UE 114 because it is within the coverage area 108. In some examples, whether RF resources are available or not available may be determined with respect to various heuristics, such as signal strength, RSSI, SINR, etc., with respect to one or more thresholds.

In some examples, the UE 114 may initially be in the coverage area 104 and may be connected to the base station 102 (either actively connected or idle). When the UE 114 exits the coverage area 104, the first RF resources may not be available to the UE 114. For example, the signal strength may be below a threshold or may disappear entirely. In some examples, the UE 114 may scan the first RF resources to determine that the first RF resources are not available to the UE 114.

Next, the UE state data component 118 can determine one or more conditions of the UE 114 to determine a probability that the UE 114 is being viewed (e.g., a visual interface of the UE 114, such as a display, is being viewed by the user of the UE). In some examples, the UE state data component 118 can determine one or more of the following: a screen saver status of the UE (e.g., if a screen saver is active or not); a locked status of the UE (e.g., if the screen of the UE is locked or otherwise idle); a power mode of the UE (e.g., whether the UE is plugged into shore power, whether the UE is charging, if the battery level is above a threshold, etc.); a sleep mode of the UE (e.g., if the UE is in a low-power state due to inactivity); a display orientation of the UE (e.g., if a display of the UE is oriented down (e.g., such as if the UE is face down on a table), if the display is oriented upwards, if the UE is vertical in a pocket of a user, if the UE is in portrait or landscape mode, and the like); a location status of the UE (e.g., if the UE is moving, a speed or velocity of the UE, if the UE is near a home location, and the like); a camera status of the UE (if the camera is active or inactive, if the camera is blocked, etc.); a noise mode of the UE (e.g., if the UE is in “silent mode,” if the UE is in “do not disturb mode,” and the like); whether a face is detected by the UE; or a motion state of the UE (e.g., based on GPS information, accelerometer information, and the like).

In some examples, the UE state data component 118 can be based at least in part on one or more heuristics and/or machine learned models that ingests one or more data as described herein and outputs state data regarding the state of the UE and/or a probability that the UE is being viewed.

In this example, the UE state data component 118 can determine that a probability that the UE 114 is being viewed is above a threshold. In some examples, the threshold can be a static threshold, while in some examples it can be a dynamic threshold (e.g., based on UE charge status or whether the UE is connected to external power). In other examples, the threshold can be learned or otherwise determined by a machine learned model.

In some examples, when the first RF resources are not available (e.g., the base station 102 is not available) and/or when the probability that the UE is being viewed by a user is above (e.g., meets or exceeds) a threshold, the UE 114 can scan for second RF resources associated with the satellite 106 (e.g., the non-terrestrial network). In some examples, the UE 114 can receive a system information block (or other information) transmitted by the satellite 106, which can provide information to the UE 114 to attach to the satellite 106. After receiving the system information block, the UE 114 can initiate a communication with the satellite 106 based on the information contained in the system information block.

Once the connection 116 is established between the UE 114 and the satellite 106, the symbol component 120 can determine to update a symbol displayed on the UE to indicate that the UE is connected to the non-terrestrial network.

The detailed view 122 illustrates various information presented by the UE 114. For example, the UE 114 includes a display 124 for presenting information and for interacting with a user. A status bar 126 is typically shown at the top of the display 124. In this example, the status bar 126 includes a signal strength meter 128, a carrier identifier 130, a first network identifier 132 indicating a type of radio access technology associated with a connection (e.g., in the case, the connection 116), and/or a second network identifier 134 (e.g., indicating that a connection is a terrestrial connection or a non-terrestrial connection). As illustrated, the second network identifier 134 is represented by a satellite icon, although other identifiers (e.g., such as the text “NTN” (to designate a non-terrestrial network)) may be used. The status bar 126 also indicates the current time of day in a time field 136.

Of course, although only two network identifiers 132 and 134 (also referred to as connection status symbols) are illustrated it can be understood that any number of network identifiers can be used in accordance with the techniques discussed herein.

The signal strength meter 128 illustrates the strength and/or quality of signals or communication channels that have been established with one or more of an LTE base station and/or an NR base station (terrestrial or otherwise). The carrier identifier 130 corresponds to the network carrier or provider whose signals are being used for communications.

The network identifier 132 indicates the type of network that is being used by the UE 114. More specifically, the displayed network identifier 132 corresponds to and identifies the wireless communication standard that is currently being used for communications by the communication device. In examples, the network identifier 132 indicates LTE when operating in a 4G LTE environment and the network identifier indicates 5G when operating in a 5G environment (e.g., either standalone and/or dual connectivity). In some examples, the network indicator 134 may display a satellite or other text (e.g., “NTN”) when the UE is connected to a satellite, while in some examples, the symbol component 120 may present a symbol of the earth or the ground or text to indicate a terrestrial network connection when connected to a terrestrial network. In some examples, the identifier 134 may be omitted when connected with a terrestrial network. Of course, other examples may have different types of networks, corresponding to different communication protocols, and may use symbols corresponding to those communication protocols. For example, a “5G” network identifier can be presented when connected via a standalone NR base station and a “DC,” “EN-DC,” “4G & 5G,” and the like can be presented in a dual connectivity environment.

It is generally intended for the status bar 126 to show a network identifier 132 corresponding to the most advanced or highest-capability cellular network that is available for use by the UE 114. In some instances, a 5G symbol is displayed whenever the UE 114 is in a location where 5G communications are available, based at least in part on a policy, and/or in accordance with the techniques discussed herein.

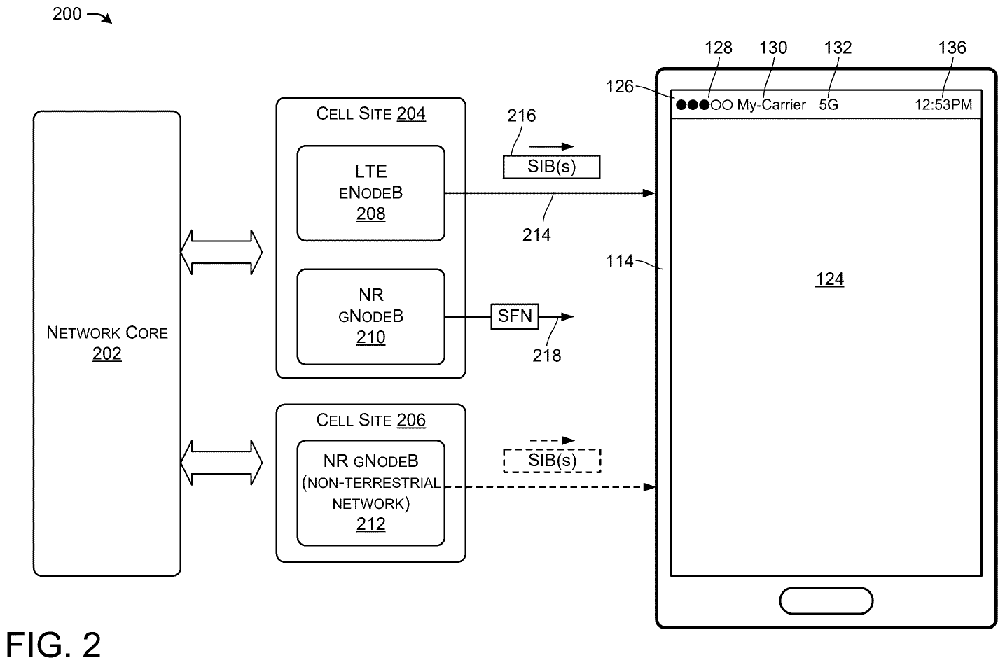

FIG. 2 is a block diagram of a communication network 200 that implements terrestrial and/or non-terrestrial 4G technologies and 5G technologies and a user equipment implementing the techniques discussed herein.

The communication network 200 (also referred to as a system 200) comprises a network core 202, which may include a 4G network core and/or a 5G network core. The communication network 200 (also referred to as a communication system 200) may comprise multiple cell sites 204 and 206, only two of which are shown in FIG. 2 for purposes of discussion.

In some examples, the network core 202 can include 4G core network comprising a Mobility Management Entity (MME), a Serving Gateway (SGW), a Packet Data Network (PDN) Gateway (PGW), a Home Subscriber Server (HSS), an Access Network Discovery and Selection Function (ANDSF), an evolved Packet Data Gateway (ePDG), a Data Network (DN), and the like.

In some examples, the network core 202 can include a 5G core network comprising any of an Access and Mobility Management Function (AMF), a Session Management Function (SMF), a Policy Control Function (PCF), an Application Function (AF), an Authentication Server Function (AUSF), a Network Slice Selection Function (NSSF), a Unified Data Management (UDM), a Network Exposure Function (NEF), a Network Repository Function (NRF), a User Plane Function (UPF), a Data Network (DN), and the like.

The illustrated cell site 204 supports both 4G and 5G communications, and therefore has both 4G and 5G cellular access points. The 4G access point is implemented as an LTE base station 208, also referred to as an eNodeB, a primary eNodeB, or a primary base station. The 5G access point is implemented as an NR base station 210, also referred to as a gNodeB, a secondary gNodeB, or a secondary base station. In some examples, the cell site 204 may comprise only a single eNodeB or a single gNodeB. In some examples, the cell site 204 may correspond to the base station 102 of FIG. 1. In some examples, the base station 102 can correspond to one of the LTE eNodeB 208 or the gNodeB 210. In some examples, the cell site 204 may represent a terrestrial network.

In some examples, the cell site 206 includes a NR gNodeB 212. In some examples, the cell site 206 correspond to the satellite 106 of FIG. 1. In some examples, the cell site 206 can represent a non-terrestrial network.

The network core 202 communicates with the LTE base station 208, the NR base station 210, and/or the NR base station 212. In the example where the cell site 204 supports the eNodeB 208 and the gNodeB 210, in some implementations, radio communications can be controlled by the LTE primary base station 208. Other communication paths may be used in other examples. Note that some cell sites of the system 200 might lack 5G support, and may support only 4G services and communications (and vice versa).

In some instances, the LTE base station 208 is not limited to LTE technology, and may be referred to generally as a first base station 208. In some instances, the NR base station 210 is not limited to NR technology, and may be referred to generally as a second base station 210. In some instances, depending on an implementation, the LTE base station 208 can be referred to as a primary base station while the NR base station 210 can be referred to as a secondary base station. In some instances (e.g., in a MR-DC context), depending on an implementation (e.g., Option 4), the LTE base station 208 can be referred to as a secondary base station while the NR base station 210 can be referred to as a primary base station. In some instances, the LTE base station 208 and the NR base station 210 may be referred to a base station 208 and a base station 210, respectively.

In some examples, the cell site 204 can be a primary cell site and the cell site 206 can be a secondary cell site (e.g., in the context of dual connectivity, etc.).

In some examples, the LTE eNodeB 208 can utilize a 4G radio technology. The base station 208 may transmit and receive data via a connection (e.g., at least one LTE radio link) that is defined according to frequency bands included in, but not limited to, a range of 450 MHz to 5.9 GHz. In some instances, the frequency bands utilized for the base station 208 can include, but are not limited to, LTE Band 1 (e.g., 2100 MHz), LTE Band 2 (1900 MHZ), LTE Band 3 (1800 MHZ), LTE Band 4 (1700 MHZ), LTE Band 5 (850 MHz), LTE Band 7 (2600 MHZ), LTE Band 8 (900 MHZ), LTE Band 20 (800 MHz GHz), LTE Band 28 (700 MHz), LTE Band 38 (2600 MHz), LTE Band 41 (2500 MHZ), LTE band 48 (e.g., 3500 MHZ (the CBRS band)), LTE Band 50 (1500 MHz), LTE Band 51 (1500 MHz), LTE Band 66 (1700 MHZ), LTE Band 70 (2000 MHz), LTE Band 71 (e.g., a 600 MHz band), LTE Band 74 (1500 MHz), and the like.

In some examples, the base station 208 can be, or at least include, an eNodeB. In some instances, the NR gNodeB 210 and/or 212 can also utilize a 5G radio technology, such as technology specified in the 5G NR standard, as defined by 3GPP. In certain implementations, the base stations 210 and/or 212 can transmit and receive communications with devices over a connection (e.g., at least one NR radio link) that is defined according to frequency resources including but not limited to 5G Band 1 (e.g., 2080 MHz), 5G Band 2 (1900 MHZ), 5G Band 3 (1800 MHZ), 5G Band 4 (1700 MHZ), 5G Band 5 (850 MHz), 5G Band 7 (2600 MHZ), 5G Band 8 (900 MHz), 5G Band 20 (800 MHZ), 5G Band 28 (700 MHz), 5G Band 38 (2600 MHZ), 5G Band 41 (2500 MHz), NR Band 48 (e.g., 3500 MHZ (the CBRS band)), 5G Band 50 (1500 MHz), 5G Band 51 (1500 MHz), 5G Band 66 (1700 MHZ), 5G Band 70 (2000 MHz), 5G Band 71 (e.g., a 600 MHz band), 5G Band 74 (1500 MHz), 5G Band 257 (28 GHz), 5G Band 258 (24 GHz), 5G Band 260 (39 GHz), 5G Band 261 (28 GHz), and the like. In some examples, the base stations 210 and/or 212 can be, or at least include, a gNodeB.

FIG. 2 also shows a single UE 114 (also referred to as a cellular communication device 114 or a device 114), which may be one of many such devices that are configured for use with the communication network 200. In the described example, the UE 114 supports both 4G/LTE and 5G/NR networks and communications. Further, in the described example, the UE 114 supports both terrestrial networks and non-terrestrial networks. Accordingly, the UE 114 includes an LTE radio (not shown) that communicates wirelessly with an LTE base station 208 of the cell site 204 and an NR radio (not shown) that communicates wirelessly with the NR base station(s) 210 of the cell site 204 and/or the NR base station 212 of the cell site 206.

The device 114 may comprise any of various types of wireless cellular communication devices that are capable of wireless data and/or voice communications, including smartphones and other mobile devices, “Internet-of-Things” (IoT) devices, smart home devices, computers, wearable devices, entertainment devices, industrial control equipment, etc. Further examples can include, but are not limited to, smart phones, mobile phones, cell phones, tablet computers, portable computers, laptop computers, personal digital assistants (PDAs), electronic book devices, or any other portable electronic devices that can generate, request, receive, transmit, or exchange voice, video, and/or digital data over a network. Additional examples of UEs include, but are not limited to, smart devices such as televisions, refrigerators, washing machines, dryers, smart mirrors, coffee machines, lights, lamps, temperature sensors, leak sensors, water sensors, electricity meters, parking sensors, music players, headphones, or any other electronic appliances that can generate, request, receive, transmit, or exchange voice, video, and/or digital data over a network.

In general, the UE 114 can include any device that is capable of transmitting/receiving data wirelessly using any suitable wireless communications/data technology, protocol, or standard, such as Global System for Mobile communications (GSM), Time Division Multiple Access (TDMA), Universal Mobile Telecommunications System (UMTS), Evolution-Data Optimized (EVDO), Long Term Evolution (LTE), Advanced LTE (LTE+), New Radio (NR), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VOIP), VOLTE, Institute of Electrical and Electronics Engineers' (IEEE) 802.1x protocols, WiMAX, Wi-Fi, Data Over Cable Service Interface Specification (DOCSIS), digital subscriber line (DSL), CBRS, and/or any future Internet Protocol (IP)-based network technology or evolution of an existing IP-based network technology. The UE 114 can implement enhanced Mobile Broadband (eMBB) communications, Ultra Reliable Low Latency Communications (URLLCs), massive Machine Type Communications (mMTCs), and the like.

The device 114 may communicate through one or more of the LTE base station 208, the NR base station 210, and/or the NR base station 212. In some instances, the device 114 may support Dual Connectivity communications, in which a single communication session might simultaneously use both a 4G connection and a 5G connection. More specifically, the device 114 may operate using what is referred to as a Non-Standalone Architecture (NSA), using 5G radio technologies to augment 4G communication capabilities. When using NSA, the device 114 can use both an LTE carrier and an NR carrier for downlink data reception and uplink transmissions.

When the device 114 is in idle mode, it can receive an LTE Radio Resource Control (RRC) signal 214 from the LTE base station 208. In some examples, the device 114 can receive a signal (e.g., similar to the signal 214) from the NR base station(s) 210 and/or 212. The RRC signal 214 may be broadcast for reception by multiple communication devices, and may contain information regarding capabilities and characteristics of the LTE base station 208. For example, RRC messaging may include information needed by a communication device to establish bi-directional communications with the LTE base station 208. In the LTE environment, at least some of this information is provided in a periodically broadcast master information block (MIB) and multiple system information blocks (SIBs). FIG. 2 shows a single SIB 216 that is being broadcast by the LTE base station 208. The SIB 216 can be received by multiple communication devices, including the illustrated device 114.

The device 114 does not necessarily maintain a connection with the NR base station 210 when the device 114 is operating in idle mode. Furthermore, the NR base station 210 may not transmit SIBs or other RRC signaling. However, 3GPP specifications indicate that the NR base station 210 is to transmit System Frame Numbers (SFNs) that are used for timing of communications. FIG. 2 shows an RF SFN signal 218 transmitted by the NR base station 210. The RF SFN signal 218 is used to convey SFN information.

In certain implementations, the device 114 does not monitor or decode the NR SFN information when the device 114 is in idle mode. Although the RF SFN signal 218 may be broadcast and available to the device 114, when in idle mode the communication device 114 does not demodulate or decode the RF SFN signal 218 to obtain the SFNs.

In an example in which the RF resources (e.g., from the LTE eNodeB 208 and/or the NR gNodeB 210) are not available at the device 114, the device 114 can initiate scanning for RF resources provided by the cell site 206. Accordingly, the UE 114 can receive a MIB, a SIB, and/or a SFN from the NR base station 212 to establish a communication between the UE 114 and the non-terrestrial network provided by the cell site 206 (and the gNodeB 212). In some examples, the UE 114 can attach to the NR gNodeB 212 as a standalone network connection.

As noted above, the device 114 includes the display 124 for presenting information and for interacting with a user. The status bar 126, the signal strength meter 128, the carrier identifier 130, the network identifier 132, and the time field 136 are discussed above and throughout this disclosure.

In certain implementations, a network availability indicator is included in one of the SIB(s) 216 that is broadcast periodically by the LTE base station 206 and/or by the NR base station(s) 210 and/or 212. The network availability indicator can indicate whether the UE 114 is in a geographic area within which 4G and/or 5G services are available.

In some examples, the network identifier 132 may comprise a variable in the SIB, where the variable has a positive value when 5G services are available, and a negative value when 5G services are not available. In some examples, this variable comprises an “upperLayerIndication” value that is contained in SIB2, in accordance with 3GPP TS 36.331 Release 15.

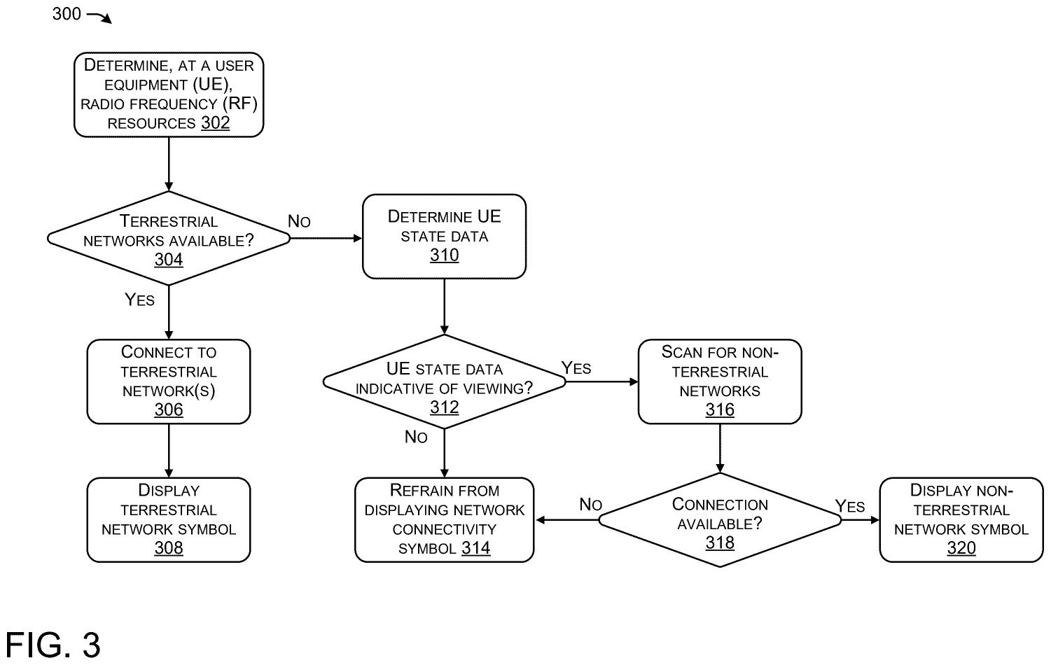

FIG. 3 is an example process 300 for signal scanning and symbol presentation for various terrestrial and non-terrestrial networks, as discussed herein. The example process 300 can be performed by the UE 114, in connection with other components and/or devices discussed herein. Some or all of the process 300 can be performed by one or more devices or components in the environment 100 and/or the network 200, for example.

At operation 302, the process can include determining, at a user equipment (UE), radio frequency resources (e.g., that are available to the UE at a particular location). In some examples, the operation 302 can include scanning through a subset of frequencies based on previously stored or obtained information. For example, the UE can be preconfigured to determine that particular frequency resources are generally available for networks in particular areas.

At operation 304, the process can include determining whether terrestrial networks are available. For example, the operation 304 can include scanning first RF resources associated with terrestrial networks to determine if the resources are available. In some examples, the operation 304 can include scanning for a MIB, SIB, and/or SFN, as discussed herein. In some examples, the operation 304 can include determining network metrics such as signal strength, bandwidth, latency, jitter, SINR, Quality of Service (QOS), Quality of Experience (QoE), etc. and comparing the metric to a configurable threshold to determine if the terrestrial network is available.

If a terrestrial network is available (“yes” at operation 304) the process continues to operation 306.

At operation 306, the process can include connecting to terrestrial network(s). In some examples, the operation 306 can include connecting to a 3G network, a 4G network, a 5G network, a Wi-Fi network, and the like (e.g., the operation 306 can include connecting to any terrestrial network discussed herein). In some examples, the operation 306 can include standalone connections, dual-connectivity, carrier aggregation, and the like.

At operation 308, the process can include displaying a terrestrial network symbol. In some examples, the operation can include presenting a network indicator such as “3G,” “4G,” “LTE,” “4G LTE,” “5G,” “DC” (for dual connectivity), “EN-DC,” and the like. In some examples, the operation 308 can include a symbol indicating that the connection is a terrestrial connection (e.g., with an icon of the earth, text “TN” (for terrestrial network, and the like), and in some examples, the operation 308 can omit a specific terrestrial indication as default. Additional symbols a techniques for presenting such symbols are discussed throughout the disclosure.

Returning to operation 304, if the terrestrial network is not available (“no” in operation 304) the process continues to operation 310.

At operation 310, the process can include determining UE state data. Examples of UE state data are discussed throughout this disclosure, but in general, the operation 310 can include, but is not limited to determining one or more of the following data or conditions: whether a display of the UE is on, whether a lock screen or screen saver is active, whether the device is locked, a display orientation (e.g., face up/face down, portrait or landscape orientation, and the like), whether the device's camera is obscured, a camera status (e.g., whether the camera is being used or not), whether a human face can be detected with the camera, whether the device is facing downward, whether the device is moving, and so forth. Additional UE state data determined in the operation 310 may include, but are not limited to, whether the device is plugged into power or is charging, a battery level of the device, a type of application running on the device or a call to be made, a time of day, congestion information and/or latency information associated with one or more networks, and the like.

At operation 312, the process can include determining whether the UE state data is indicative of the UE being viewed. In some examples, the operation 312 can include inputting the UE state data determined in the operation 310 to a model (e.g., a heuristic based model, a machine learned model, and the like). In some examples, the model can output a binary indication whether the UE is being viewed and/or the model can output a probability indicating whether the UE is likely being viewed. In some examples, the operation 312 can include determining whether the probability that the UE is being viewed meets or exceeds a threshold probability level. In some examples, the threshold probability level can be static or dynamic. In some examples, the threshold probability level can be determined based on one or more heuristics and/or based on an output from a machine learned model trained to output a threshold probability level.

If the UE state data is not indicative of the UE being viewed (“no” in operation 312) the process can continue to operation 314.

At operation 314, the process can include refraining from displaying a network connectivity symbol. In some examples, the operation 314 can include periodically scanning for available networks at regular or irregular intervals. In some examples, the process can return to the operation 302 to determine whether RF resources are available at the UE. As noted herein, the operation 314 can include setting a timer and changing the period of time between scanning. Such scanning behavior can reduce power consumption at the UE and can prevent unnecessary network congestion and/or signaling by the UE if the UE is searching for a network. As can be understood, any by way of example and without limitation, the UE can perform a first action (or refrain from performing a first action) while the timer is counting (or active) and can perform a second action (or refrain from performing a second action) when the timer has expired (or upon determining an expiration of the timer).

If the UE state data is indicative of viewing (“yes” at operation 312) the process can continue to operation 316.

At operation 316, the process can include scanning for non-terrestrial networks. In some examples, the operation 316 can include scanning second RF resources allocated to non-terrestrial networks. In some examples, the operation 316 can include the UE searching for one or more of a MIB, SIB, SFN, and the like.

At operation 318, the process can include determining whether a connection (e.g., with a non-terrestrial network) is available. In some examples, the operation 318 can include determining network metrics such as signal strength, bandwidth, latency, jitter, SINR, QOS, QoE, etc. and comparing the metric to a configurable threshold to determine if the non-terrestrial network is available.

If the non-terrestrial connection is not available (“no” in operation 318) the process continues to the operation 314. If the non-terrestrial connection is available (“yes” in operation 318) the process continues to operation 320.

At operation 320, the process can include displaying a non-terrestrial network symbol. For example, the operation 320 can include displaying a symbol of a satellite or the text “NTN” to indicate a non-terrestrial network, although other symbols can be used. In some examples, the operation 320 can include setting a timer to prevent the symbol from “flickering” or changing rapidly in the event of changed conditions. In some examples, the operation 320 can include presenting a symbol indicating the non-terrestrial connection during the connection period and for a period of time after the connection has shifted to idle. In some examples, the operation 320 can return to 302 after a predetermined period of time.

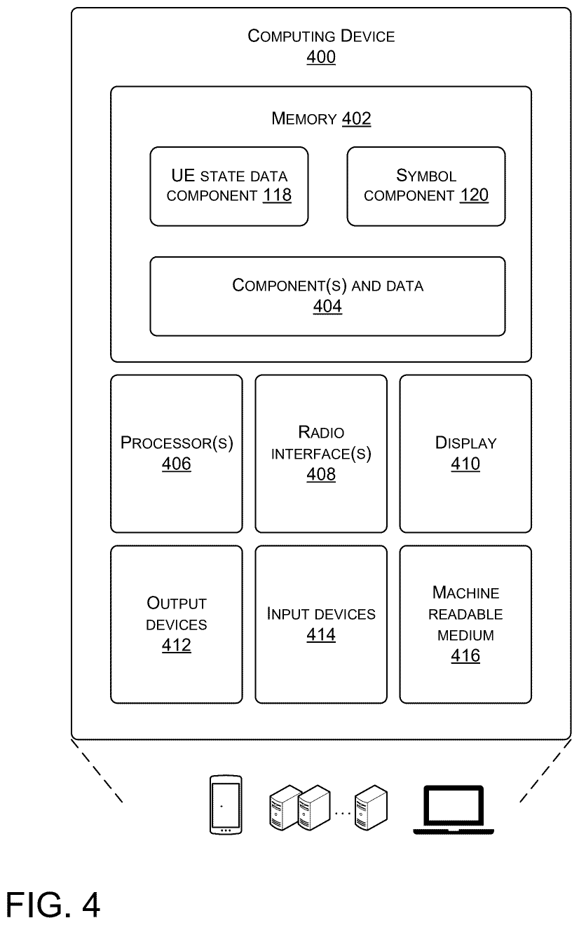

FIG. 4 illustrates an example computing device 400 to implement the symbol determination and/or presentation techniques, as discussed herein. In some examples, the computing device 400 can correspond to the UE 114 of FIG. 1. It is to be understood in the context of this disclosure that the computing device 400 can be implemented as a single device, as a plurality of devices, or as a system with components and data distributed among them.

As illustrated, the computing device 400 comprises a memory 402 storing a UE state data component 118, a symbol component 120, and/or component(s) and data 404. Also, the computing device 400 includes processor(s) 406, radio interface(s) 408, a display 410, output devices 412, input devices 414, and a machine readable medium 416.

In various implementations, the memory 402 is volatile (such as RAM), non-volatile (such as ROM, flash memory, etc.) or some combination of the two. The UE state data component 118, the symbol component 120, and the component(s) and data 404 stored in the memory 402 can comprise methods, threads, processes, applications or any other sort of executable instructions. The UE state data component 118, the symbol component 120, and the component(s) and data 404 can also include files and databases.

In general, the UE state data component 118 can include functionality to determine a state of a network and/or a device, and/or an applicable policy, for displaying or otherwise presenting a symbol indicative of a wireless resource. In some examples, the symbol component 120 can present a 4G or 5G symbol (or any other symbol, such as to distinguish between terrestrial and non-terrestrial networks) on a display of a UE in accordance with the techniques discussed herein.

In some examples, the UE state data component 118 can include functionality to receive network information or otherwise determine a state of network resources. In some examples, the UE state data component 118 can determine whether 4G wireless resources and/or 5G wireless resources are available to a UE (e.g., via an RRC, MIB, SIB, and/or upperLayerIndication flag). In some examples, the UE state data component 118 can determine a signal strength of one or more of a 4G signal or 5G signal (terrestrial or otherwise). In some examples, the UE state data component 118 can estimate an availability of the 4G base station based least in part on a signal strength (or other metric) associated with the 4G base station. For example, based on the signal strength of a 4G signal, the UE state data component 118 can look up or determine (e.g., via a look up table associated with a particular location and/or frequency combinations (e.g., of the 4G base station and the 5G base station)), what an estimated signal strength of the 4G base station is expected to be.

In some examples, the UE state data component 118 can include functionality to determine a connection state of a UE. For example, the UE state data component 118 can determine whether the UE is connected (e.g., actively communicating) or idle.

In some examples, the symbol component 120 can include functionality to determine a policy associated with presenting a symbol, as discussed herein. In some examples, the symbol component 120 can receive a message or instruction to activate a policy for presenting a symbol. In some examples, based on the network state, the device state, and/or an applicable policy, the symbol component 120 can determine a symbol to present indicative of a wireless resource.

In various examples, the processor(s) 406 can be a central processing unit (CPU), a graphics processing unit (GPU), or both CPU and GPU, or any other type of processing unit. Each of the one or more processor(s) 806 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 406 may also be responsible for executing all computer applications stored in the memory 402, which can be associated with common types of volatile (RAM) and/or nonvolatile (ROM) memory.

The radio interfaces 408 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the radio interfaces 408 can be compatible with multiple radio access technologies, such as 5G radio access technologies and 4G/LTE radio access technologies. Accordingly, the radio interfaces 408 can allow the computing device 400 to connect to various components as described herein.

The display 410 can be a liquid crystal display or any other type of display commonly used in computing devices. For example, display 410 may be a touch-sensitive display screen, and can then also act as an input device or keypad, such as for providing a soft-key keyboard, navigation buttons, or any other type of input. The output devices 412 can include any sort of output devices known in the art, such as the display 410, speakers, a vibrating mechanism, and/or a tactile feedback mechanism. Output devices 412 can also include ports for one or more peripheral devices, such as headphones, peripheral speakers, and/or a peripheral display. The input devices 414 can include any sort of input devices known in the art. For example, input devices 414 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 416 can store one or more sets of instructions, such as software or firmware, that embodies any one or more of the methodologies or functions described herein. The instructions can also reside, completely or at least partially, within the memory 402, processor(s) 406, and/or radio interface(s) 408 during execution thereof by the computing device 400. The memory 402 and the processor(s) 406 also can constitute machine readable media 416.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

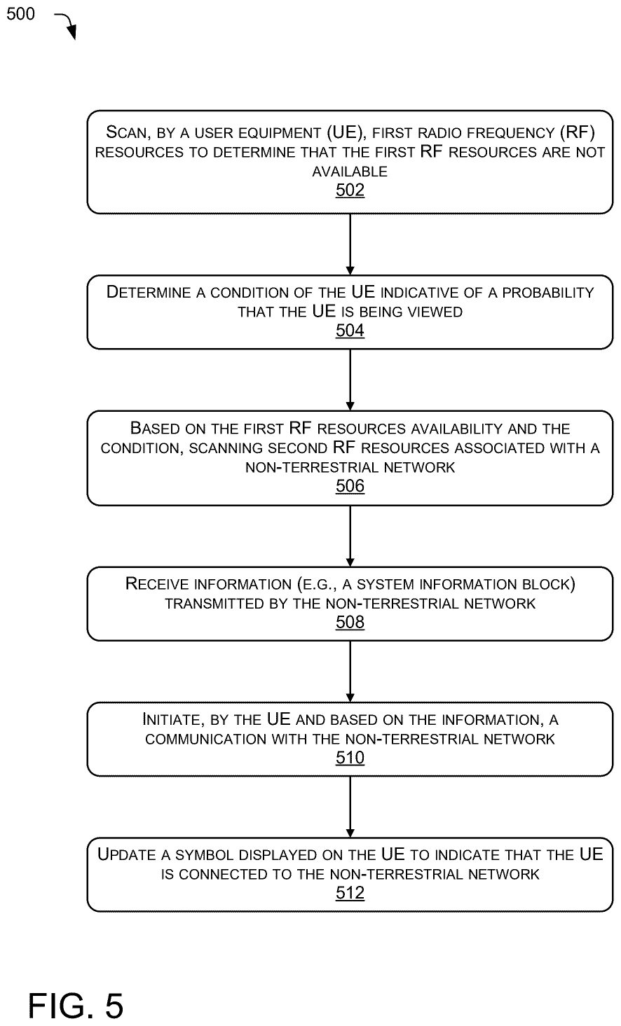

FIGS. 3 and 5 illustrate example processes in accordance with examples of the disclosure. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

FIG. 5 illustrates an example process 500 for signal scanning and/or symbol presentation for non-terrestrial networks. The example process 500 can be performed by the UE state data component 118, the symbol component 120 (and/or another component), in connection with other components and/or devices discussed herein. Some or all of the process 500 can be performed by one or more devices or components in the network 200, for example.

At operation 502, the process can include scanning, but a user equipment (UE), first radio frequency (RF) resources to determine that the first RF resources are not available. In some examples, the UE may have previously been in contact with or in communication with a terrestrial base station (e.g., either a 4G and/or a 5G base station) associated with the first RF resources.

At operation 504, the process can include determining a condition of the UE indicative of a probability that the UE is being viewed. In some example, the operation 504 can include determining UE state data, as discussed herein.

At operation 506, the process can include scanning, based on the first RF resources not being available, second RF resources associated with a non-terrestrial network. In some example, the UE may be aware that particular RF resources are associated with a non-terrestrial network and may scan the second RF resources as a fallback when the first RF resources are not available.

At operation 508, the process can include receiving information (e.g., a system information block (SIB), a master information block (MIB), or a system frame number (SFN)) transmitted by the non-terrestrial network. In some examples, the information from the non-terrestrial network can be used to configure a connection to assist the UE with attaching to the non-terrestrial network.

At operation 510, the process can include initiating, by the UE and based on the information (e.g., received in the operation 508), a communication with the non-terrestrial network. In some examples, the operation 510 can include establishing a bearer for the communication and/or exchanging data with the non-terrestrial network.

At operation 512, the process can include updating a symbol displayed on the UE to indicate that the UE is connected to the non-terrestrial network. In some examples, the UE can display a first symbol indicating a network architecture (e.g., “4G,” “5G,” and the like) and a second symbol indicating that the network is a non-terrestrial network (e.g., with a satellite icon, with text indicating “NTN,” and the like.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A user equipment (UE) comprising:
one or more processors; and
one or more non-transitory computer readable media storing computer executable instructions that, when executed, cause the one or more processors to perform operations comprising:
scanning, by the UE, first radio frequency (RF) resources to determine that the first RF resources are not available to the UE;
determining a condition of the UE indicative of a probability that a display of the UE is being viewed;
determining that the probability meets or exceeds a threshold probability level;
based at least in part on determining that the first RF resources are not available and based at least in part on the probability meeting or exceeding the threshold probability level, scanning second RF resources associated with a non-terrestrial network;
receiving a system information block (SIB) transmitted by the non-terrestrial network;
initiating, by the UE and based at least in part on the SIB, a communication with the non-terrestrial network; and
updating a symbol displayed on the UE to indicate that the UE is connected to the non-terrestrial network.

2. The user equipment of claim 1, wherein the symbol further indicates a type of radio access technology provided by the non-terrestrial network.

3. The user equipment of claim 2, wherein the symbol is a first symbol that is different than a second symbol displayed by the UE when the UE is connected to a terrestrial network associated with the radio access technology.

4. The user equipment of claim 1, wherein determining the condition is based at least in part on at least one of:
a screen saver status of the UE;
a locked status of the UE;
a power mode of the UE;
a sleep mode of the UE;
the display orientation of the UE;
a location status of the UE;
a camera status of the UE;
a noise mode of the UE;
whether a face is detected by the UE; or
a motion state of the UE.

5. The user equipment of claim 1, wherein the first RF resources are associated with a Fifth Generation (5G) terrestrial network and the second RF resources are associated with a 5G non-terrestrial network.

6. The user equipment of claim 1, the operations further comprising:
starting a timer in response to initiating the communication with the second RF resources; and
scanning the first RF resources based at least in part on a status of the timer.

7. The user equipment of claim 1, the operations further comprising:
starting a timer in response to initiating the communication with the second RF resources; and
determining that the communication has ended and the UE has entered an idle mode; and
refraining from updating the symbol based at least in part on the timer being active and the UE having entered the idle mode.

8. The user equipment of claim 1, wherein the communication with the non-terrestrial network is associated with a first time, the operations further comprising:
determining that the communication has failed at a second time after the first time;
based at least in part on determining that the communication has failed at the second time, initiating a timer; and
preventing the symbol from being displayed until expiration of the timer.

9. The user equipment of claim 1, wherein the first RF resources are not available at a first time and wherein the symbol is a first symbol, the operations further comprising:
scanning, by the UE, the first RF resources at a second time after the first time;
determining that the first RF resources are available to the UE at the second time;
determining that the second RF resources are available to the UE at the second time; and
removing the first symbol displayed on the UE and displaying a second symbol on the UE to indicate that the first RF resources are available to the UE.

10. The user equipment of claim 1, the operations further comprising:
refraining from displaying a connection status symbol in response to determining that the first RF resources are not available to the UE.

11. A method comprising:
scanning, by a user equipment (UE), first radio frequency (RF) resources to determine that the first RF resources are not available to the UE;
determining a condition of the UE indicative of a probability that the UE is being viewed;
determining that the probability meets or exceeds a threshold probability level;
based at least in part on determining that the first RF resources are not available and based at least in part on the probability meeting or exceeding the threshold probability level, scanning second RF resources associated with a non-terrestrial network;
receiving a system information block (SIB) transmitted by the non-terrestrial network;
initiating, by the UE and based at least in part on the SIB, a communication with the non-terrestrial network; and
updating a symbol displayed on the UE to indicate that the UE is connected to the non-terrestrial network.

12. The method of claim 11, wherein:
the symbol is a first symbol that further indicates a type of radio access technology provided by the non-terrestrial network; and
the first symbol is different than a second symbol displayed by the UE when the UE is connected to a terrestrial network associated with the radio access technology.

13. The method of claim 11, wherein determining the condition is based at least in part on at least one of:
a screen saver status of the UE;
a locked status of the UE;
a power mode of the UE;
a sleep mode of the UE;
a display orientation of the UE;
a location status of the UE;
a camera status of the UE;
a noise mode of the UE;
whether a face is detected by the UE; or
a motion state of the UE.

14. The method of claim 11, wherein the communication with the non-terrestrial network is associated with a first time, the method further comprising:
determining that the communication has failed at a second time after the first time;
based at least in part on determining that the communication has failed at the second time, initiating a timer; and
preventing the symbol from being displayed until expiration of the timer.

15. The method of claim 11, wherein the first RF resources are not available at a first time and wherein the symbol is a first symbol, the method further comprising:
scanning, by the UE, the first RF resources at a second time after the first time;
determining that the first RF resources are available to the UE at the second time;
determining that the second RF resources are available to the UE at the second time; and
removing the first symbol displayed on the UE and displaying a second symbol on the UE to indicate that the first RF resources are available to the UE.

16. One or more non-transitory computer-readable media storing computer executable instructions that, when executed, cause one or more processors to perform operations comprising:
scanning, by a user equipment (UE), first radio frequency (RF) resources to determine that the first RF resources are not available to the UE;
determining a condition of the UE indicative of a probability that the UE is being viewed;
determining that the probability meets or exceeds a threshold probability level;
based at least in part on determining that the first RF resources are not available and based at least in part on the probability meeting or exceeding the threshold probability level, scanning second RF resources associated with a non-terrestrial network;
receiving a system information block (SIB) transmitted by the non-terrestrial network;
initiating, by the UE and based at least in part on the SIB, a communication with the non-terrestrial network; and
updating a symbol displayed on the UE to indicate that the UE is connected to the non-terrestrial network.

17. The one or more non-transitory computer-readable media of claim 16, wherein:
the symbol is a first symbol that further indicates a type of radio access technology provided by the non-terrestrial network; and
the first symbol is different than a second symbol displayed by the UE when the UE is connected to a terrestrial network associated with the radio access technology.

18. The one or more non-transitory computer-readable media of claim 16, wherein determining the condition is based at least in part on at least one of:
a screen saver status of the UE;
a locked status of the UE;
a power mode of the UE;
a sleep mode of the UE;
a display orientation of the UE;
a location status of the UE;
a camera status of the UE;
a noise mode of the UE;
whether a face is detected by the UE; or
a motion state of the UE.

19. The one or more non-transitory computer-readable media of claim 16, wherein the communication with the non-terrestrial network is associated with a first time, the operations further comprising:
determining that the communication has failed at a second time after the first time;
based at least in part on determining that the communication has failed at the second time, initiating a timer; and
preventing the symbol from being displayed until expiration of the timer.

20. The one or more non-transitory computer-readable media of claim 16, wherein the first RF resources are not available at a first time and wherein the symbol is a first symbol, the operations further comprising:
scanning, by the UE, the first RF resources at a second time after the first time;
determining that the first RF resources are available to the UE at the second time;
determining that the second RF resources are available to the UE at the second time; and
removing the first symbol displayed on the UE and displaying a second symbol on the UE to indicate that the first RF resources are available to the UE.
